(19) United States
(12) Patent Application Publication
(10) Pub. No.: US 2005/0001105 A1
(43) Pub. Date: Jan. 6, 2005

(54) Vehicle-mounted electronic device

(76) Inventors: Akihiro Matsuda, Yokohama-shi (JP); Ryoichi Hirako, Sagamihara-shi (JP)

Correspondence Address: ERIC ROBINSON, PMB 955, 21010 SOUTHBANK ST., POTOMAC FALLS, VA, 20165, US

(21) Appl. No.: 10/489,954

(22) PCT Filed: Oct. 24, 2002
(86) PCT No.: PCT/JP02/11057

(30) Foreign Application Priority Data
Oct. 30, 2001 (JP) 2001-331977
May 31, 2002 (JP) 2002-158759

(51) Int. Cl. G12B 9/00

(52) U.S. Cl. 248/27.1

(57) ABSTRACT

The invention provides a structure for attaching the main body and components of a vehicle-mounted electronic device, capable of increasing the size of an operation panel and a monitor for the electronic device stored in a vehicle-mounted electronic device storage section. In a first phase of the invention, in a structure for attaching a vehicle-mounted electronic device by fixing a vehicle-mounted electronic device to a vehicle, fixing a cluster panel to the vehicle in such a manner as to pass the vehicle-mounted electronic device therethrough, and fixing a panel wider than the opening in the cluster panel to the vehicle-mounted electronic device in such a manner as to place it over the cluster panel, a sub-bracket is attached to the lateral surface of the electronic device main body in such a manner that its position can be adjusted, and an attaching metal element is fastened to the sub-bracket so as to fasten the attaching metal element to the vehicle.

### BACKGROUND OF THE INVENTION

1. Field of the Invention

The present invention relates to the mount structure for mounting a vehicle-mounted electronic device, and more particularly to the mount structure suitable for mounting the main body of a vehicle-mounted electronic device having a large panel and to the mount structure for mounting an operation panel and a monitor of a vehicle-mounted electronic device.

2. Related Background Art

As shown in FIG. 13, when a vehicle-mounted electronic device such as a car stereo equipment is mounted on a housing recess of a vehicle, a mounting bracket 15 is mounted on an electronic device main body chassis 32 with screws, to mount the mounting bracket 15 on a vehicle. A cluster panel 31 is mounted covering the front side of the electronic device, and a panel 34 disposed on the front side of the electronic device main body is protruded from an opening of the cluster panel 31.

FIG. 4 shows an example of the panel 34 fixed to the electronic device main body chassis 32. In this example, a CD insertion slit 32a and a cassette insertion slit 32b are formed in the panel 34. In the example shown in FIG. 15, a panel 34 is movably mounted on an electronic device main body chassis 33. When this panel 34 is moved to the position where the front side of the electronic device is exposed, a CD insertion slit 33a appears.

With the mount structure of the conventional vehicle-mounted electronic device described above, in order to protrude the panel 34 from the opening of the cluster panel 31, the vertical and horizontal sizes a and b of the panel 34 are required to be smaller than the vertical and horizontal sizes A and B of the opening of the cluster panel 31.

Since the vertical and horizontal sizes A and B of the opening of the cluster panel 31 differ depending upon the vehicle type, the panel sizes are required to match the smallest cluster panel sizes, resulting in the small panel sizes.

Since the CD insertion slit 32a and the like of the panel 34 shown in FIG. 14 are formed through the panel plate, the display unit, operation switches and the like are required to be small. In order to make movable the panel 34 shown in FIG. 15, the complicated mechanism is required. In order to accommodate such a mechanism, the sizes of the device become large.

The present invention has been made in view of the above-described points. A first objective of the invention is to provide the mount structure for mounting a vehicle-mounted electronic device capable of providing a large area for disposing the panel display unit, operation switches and the like, with a simple mechanism.

When the above-described vehicle-mounted electronic musical instrument is to be used as a general vehicle-mounted electronic musical instrument, the instrument is required to be designed so as to match the vehicle having the smallest opening sizes of a frame-like cluster panel 31. The vertical and horizontal sizes a and b of the operation panel are therefore required to be small.

As shown in FIG. 14, since the CD insertion slit 32a and cassette insertion slit 32b are formed through the operation panel 34 fixed to the front side of the vehicle-mounted electronic musical instrument 32, the space for the display panel, operation keys and the like to be disposed on the front side of the operation panel 34 is only the remaining space excepting the space for the slits 32a and 32b. The space for the display panel and operation keys of the operation panel 34 therefore becomes smaller so that the device manipulation becomes difficult.

The operation panel 34 is mounted on the front side of the vehicle-mounted electronic musical instrument chassis 33 so as to be able to slide along an arrow shown in FIG. 15, and as the operation panel 34 slides, the CD insertion slit 33a appears. The space for the display unit device and operation keys can be broadened in amount corresponding to that the operation panel 34 is not formed with the CD insertion slit 33a. However, since the operation panel 34 is required to protrude from the frame-like cluster panel, the vertical and horizontal sizes a and b are required smaller than those of a fixed type operation panel, resulting in the difficulty in manipulation.

The present invention has been made in view of these points. A second objective of the invention is to provide a vehicle-mounted electronic device capable of increasing the sizes of the operation panel, monitor and the like constituting the electronic device to be accommodated in a vehicle-mounted electronic device housing of a vehicle having a frame-like cluster panel.

### DISCLOSURE OF THE INVENTION

In order to achieve the first objective, the invention provides a mount structure for mounting a vehicle-mounted electronic device by fixing the vehicle-mounted electronic device to a vehicle, fixing a cluster panel to the vehicle by inserting the vehicle-mounted electronic device therethrough, and fixing a panel broader than an opening of the cluster panel to the vehicle-mounted electronic device by covering the cluster panel with the panel, wherein a subsidiary bracket is mounted on a side wall of a main body of the vehicle-mounted electronic device in such a manner that a position of the subsidiary bracket can be adjusted, a mounting bracket is mounted with screws on the subsidiary bracket, and the mounting bracket is mounted with screw on the vehicle.

In the mount structure for mounting a vehicle-mounted electronic device, the subsidiary bracket is mounted on bosses formed on the side wall of the vehicle-mounted electronic device by using screws in such a manner that the screws used for mounting the mounting bracket on the subsidiary bracket are not abutted on the side wall of the main body of the vehicle-mounted electronic device.

The invention also provides a mount structure for mounting a vehicle-mounted electronic device by fixing the vehicle-mounted electronic device to a vehicle, fixing a cluster panel to the vehicle by inserting the vehicle-mounted electronic device therethrough, and fixing a panel broader than an opening of the cluster panel to the vehicle-mounted electronic device by covering the cluster panel with the panel, wherein a plurality set of tapping holes are provided for mounting with screws a mounting bracket on a side wall of a main body of the vehicle-mounted electronic device, and the mounting bracket is mounted with screws on the side wall of the main body of the vehicle-mounted electronic device by using a desired set of tapping holes in such a manner that a position of the main body of the vehicle-mounted electronic device can be adjusted when the mounting bracket is mounted with screws on the vehicle.

In order to achieve the second objective, the present invention provides a vehicle-mounted electronic device.

The present invention's vehicle-mounted electronic device comprises: a frame-like cluster panel mounted on an opening periphery of a housing recess of a vehicle, said housing recess accommodating a main body of said vehicle-mounted electronic device; panel support arms inserted into said frame-like cluster panel, said panel support arms being movably mounted on the main body of said vehicle-mounted electronic device; a panel holder mounted on top ends of said support arms; and an operation panel or a monitor mounted on said panel holder, the outer vertical and horizontal sizes of said operation panel or said monitor being greater than an inner periphery area of said frame-like cluster panel, wherein said operation panel or said monitor is disposed forward relative to said frame-like cluster panel.

In the present invention's vehicle-mounted electronic device, the panel support arms are made freely movable in and out of the frame-like cluster panel, and the operation panel or the monitor is held at a position remote from the frame-like cluster panel by a predetermined distance.

In addition in this vehicle-mounted electronic device, the operation panel or the monitor is rotatable so that a recording medium inlet of the vehicle-mounted electronic device can be opened and closed.

### BRIEF DESCRIPTION OF THE DRAWINGS

FIG. 1 is a broken perspective view of the mount structure for mounting a vehicle-mounted electronic device according to a first embodiment of the first invention.

FIG. 2 is a broken perspective view partially showing the mount structure shown in FIG. 1.

FIG. 3(a) is a broken perspective view of the mount structure for mounting a vehicle-mounted electronic device according to a second embodiment of the first invention, and FIG. 3(b) is an enlarged perspective view showing a member used for the mount structure.

FIG. 4 is a broken perspective view of the mount structure for mounting a vehicle-mounted electronic device according to a third embodiment of the first invention.

FIG. 5 is a broken perspective view illustrating the mount state of a vehicle-mounted electronic musical instrument according to a first embodiment of the second invention.

FIG. 6 is a cross sectional view illustrating the mount state of the vehicle-mounted electronic musical instrument shown in FIG. 5.

FIG. 7 is a cross sectional view illustrating another mount state of the vehicle-mounted electronic musical instrument shown in FIG. 5.

FIG. 8 is a cross sectional view illustrating still another mount state of the vehicle-mounted electronic musical instrument shown in FIG. 5.

FIG. 9 is a cross sectional view illustrating still another mount state of the vehicle-mounted electronic musical instrument shown in FIG. 5.

FIG. 10 is a perspective view partially showing the outline structure of the vehicle-mounted electronic musical instrument shown in FIG. 5.

FIG. 11 is a perspective view partially showing the vehicle-mounted electronic musical instrument shown in FIG. 5.

FIG. 12 is a broken perspective view showing the components of a vehicle-mounted electronic device according to a second embodiment of the second invention.

FIG. 13 is a broken perspective view showing an example of the mount state of a conventional vehicle-mounted electronic musical instrument.

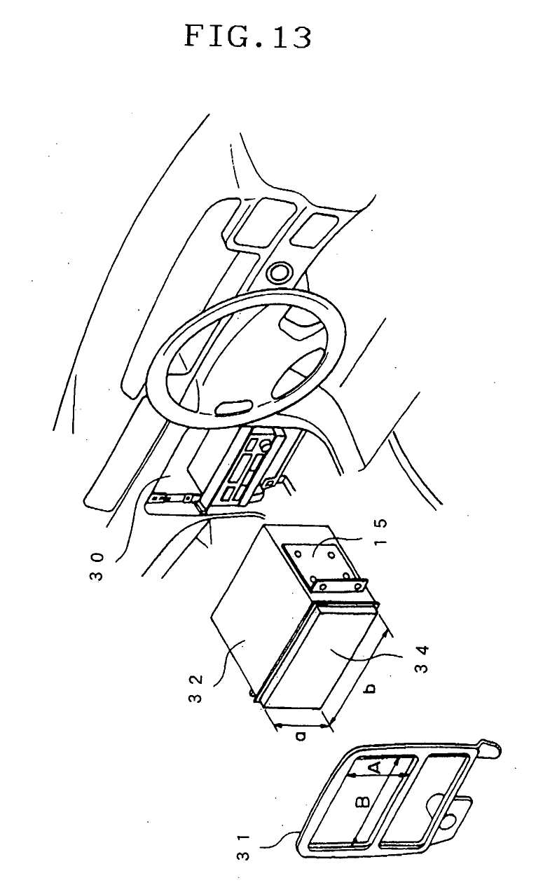

FIG. 14 is a perspective view showing an example of a conventional vehicle-mounted electronic musical instrument.

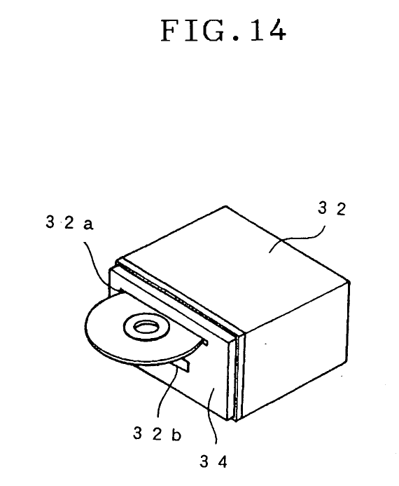

FIG. 15 is a perspective view showing another example of a conventional vehicle-mounted electronic musical instrument.

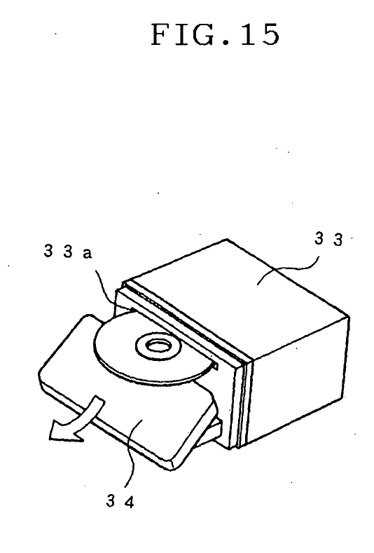

### DESCRIPTION OF THE PREFERRED EMBODIMENTS

With reference to the accompanying drawings, the mount structure for mounting a vehicle-mounted electronic device main body and the mount structure for mounting constituent elements of a vehicle-mounted electronic device will be described in connection with embodiments.

For the purpose of convenience, the invention regarding the mount structure for mounting a vehicle-mounted electronic device main body and achieving the first objective of the invention will be called the first invention, and the invention regarding the mount structure for mounting constituent elements (operation panel and monitor) of the vehicle-mounted electronic device and achieving the second objective will be called the second invention.

Embodiments of the First Invention

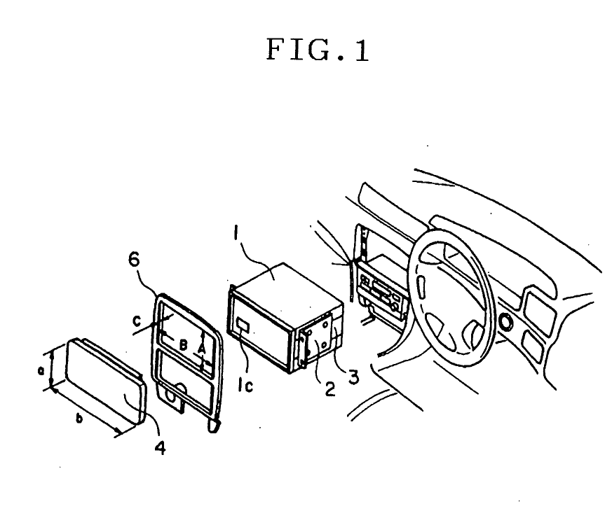

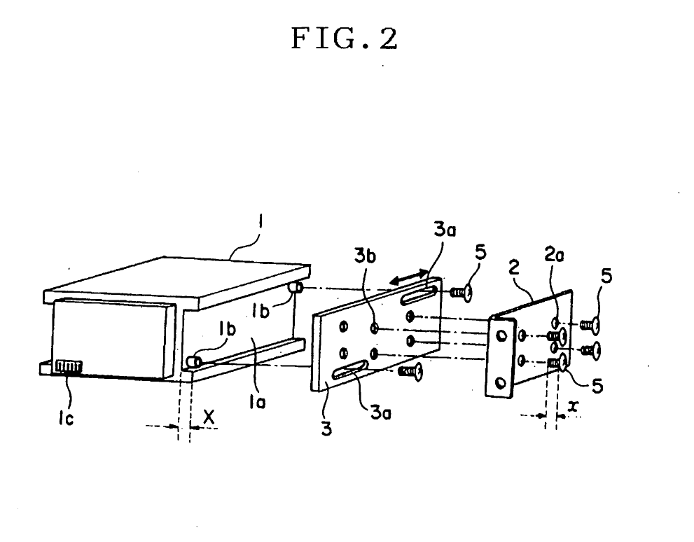

With reference to the accompanying drawings, the mount structure for mounting a vehicle-mounted electronic device according to the embodiments of the first invention will be described. FIG. 1 is a schematic broken perspective view of the mount structure for mounting a vehicle-mounted electronic device according to the first embodiment of the first invention. FIG. 2 is a partial broken perspective view showing the mount structure for mounting the vehicle-mounted electronic device shown in FIG. 1.

As shown in FIGS. 1 and 2, a subsidiary bracket 3 is mounted on an electronic device main body chassis 1 with screws, and a mounting bracket 2 is mounted on the subsidiary bracket 3 with screws. As the mounting bracket 2 is mounted on the vehicle, the electronic device main body chassis 1 is fixed to the vehicle.

Thereafter, a cluster panel 6 is fixed to the vehicle, surrounding the periphery of the electronic device main body, and a panel 4 is mounted on the electronic device main body via the cluster panel 6. At this time, a connector 1c mounted on the electronic device main body chassis 6 is coupled to a connector mounted on the panel 4 so that the panel 4 is connected to the electronic device main body.

As detailed in FIG. 2, screws 5 inserted into elongated holes 3a of the subsidiary bracket 3 are threaded into tapped holes of bosses 1b upright mounted on a side wall 1a of the electronic device main body chassis 1, so that the subsidiary bracket 3 is fixed to the chassis. Screws 5 inserted into holes 2a of the mounting bracket 2 are threaded into tapped holes 3b of the subsidiary bracket 3, so that the mounting bracket 2 is fixed to the subsidiary bracket 3.

In the state that the mounting bracket 2 is fixed to the vehicle, the positions of the screws in the elongated holes 3a of the subsidiary bracket 3 are adjusted to set the fixing position of the electronic device main body.

The adjustment range of the fixing position of the subsidiary bracket 3 is set greater than the thickness (indicated at c in FIG. 1) of the cluster panel. A large panel can be used which has the vertical and horizontal sizes a and b larger than the vertical and horizontal sizes A and B of the opening of the cluster panel 6.

The height X of the boss 1b shown in FIG. 2 is greater than the length x of the screw 5 used for fixing the mounting bracket 2. Therefore, the screw 5 for fixing the mounting bracket 2 will not pushed against the side wall 1a of the electronic device main body chassis 1.

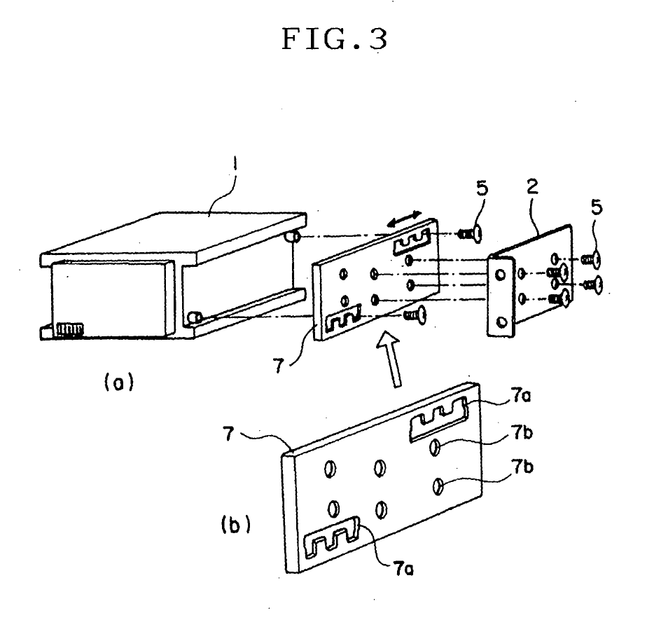

FIGS. 3(a) is a broken perspective view partially showing the mount structure for mounting a vehicle-mounted electronic device according to the second embodiment of the first invention, FIG. 3(b) is an enlarged perspective view showing a subsidiary bracket 7 used for the mount structure shown in FIG. 3(a). In this example, the subsidiary bracket 7 is fixed to the electronic device main body chassis 1 with screws 5 which are inserted into E-character shaped holes 7a formed through the sub-sidiary bracket 7. Screws 5 inserted into the holes of the mounting bracket 2 are threaded into tapped holes 7b of the subsidiary bracket 7, so that the mounting bracket 2 is fixed to the subsidiary bracket 7.

By changing the position of the screw 5 in the E-character shaped hole 7a, the position and height along a depth direction of the subsidiary bracket 7 relative to the electronic device main body chassis 1 can be adjusted. The other structures are similar to those of the first embodiment.

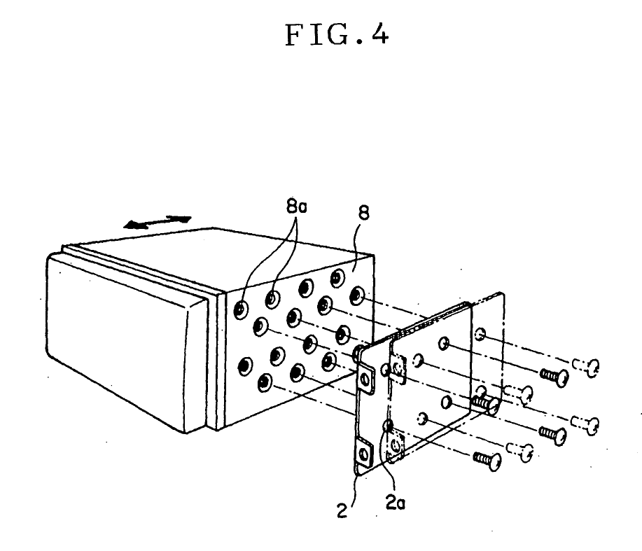

FIG. 4 is a broken perspective view partially showing the mount structure of a vehicle-mounted electronic device according to the third embodiment of the first embodiment. In this example, the mounting bracket 2 is fixed to an electronic device main body chassis 8 in direct contact therewith. A plurality of sets of four tapped holes 8a into which each set of four screws is threaded to fix the mounting bracket 2 to the electronic device main body chassis 8. By using a desired set of four tapping holes 8a, the mount position of the mounting bracket 2 relative to the electronic device main body chassis 8 can be changed. It is therefore possible to set a desired position of the electronic device main body chassis 8 relative to the vehicle. The other structures are similar to those of the first embodiment.

Embodiments of the Second Invention

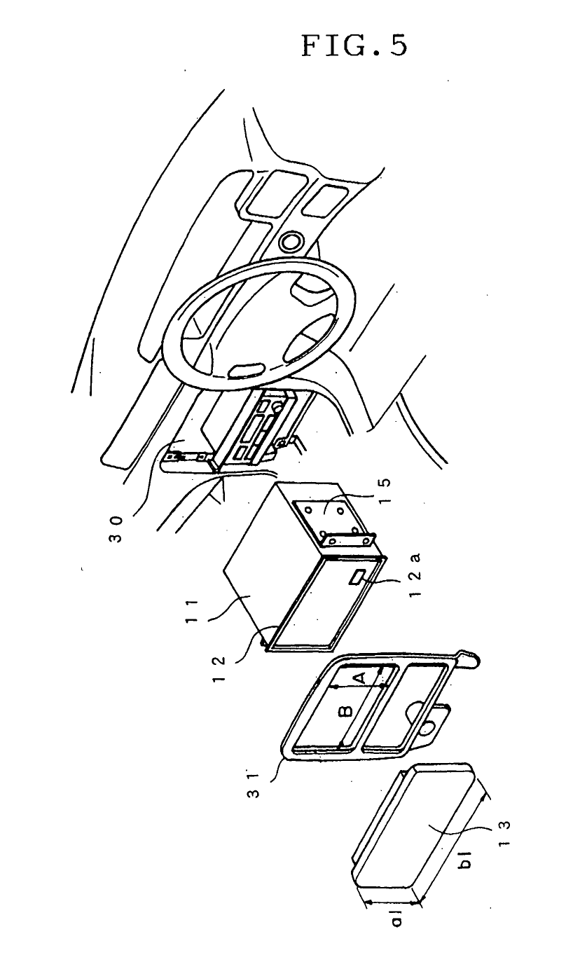

With reference to the accompanying drawings, a vehicle-mounted electronic device according to the embodiments of the second invention will be described. FIG. 5 is a schematic broken perspective view illustrating a mount state of a vehicle-mounted electronic device according to the first embodiment of the second invention. A frame-like cluster panel 31 mounted on the periphery of an opening of an electronic device housing recess 30 of the vehicle shown in FIG. 5 is dismounted and a mounting bracket 15 is mounted on the side wall of a vehicle-mounted electronic musical instrument chassis 11. The mounting bracket 15 is thereafter mounted on the vehicle.

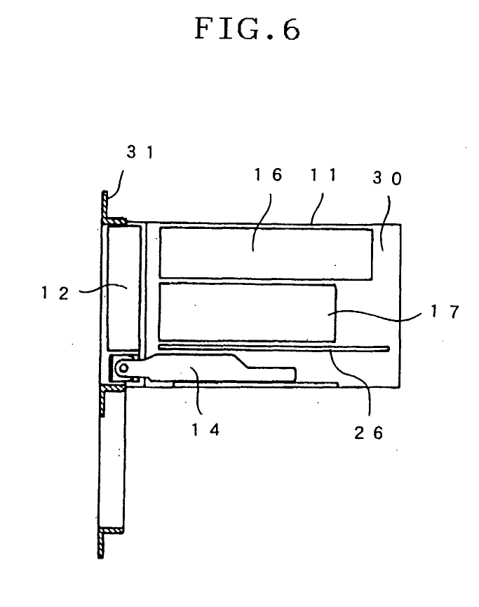

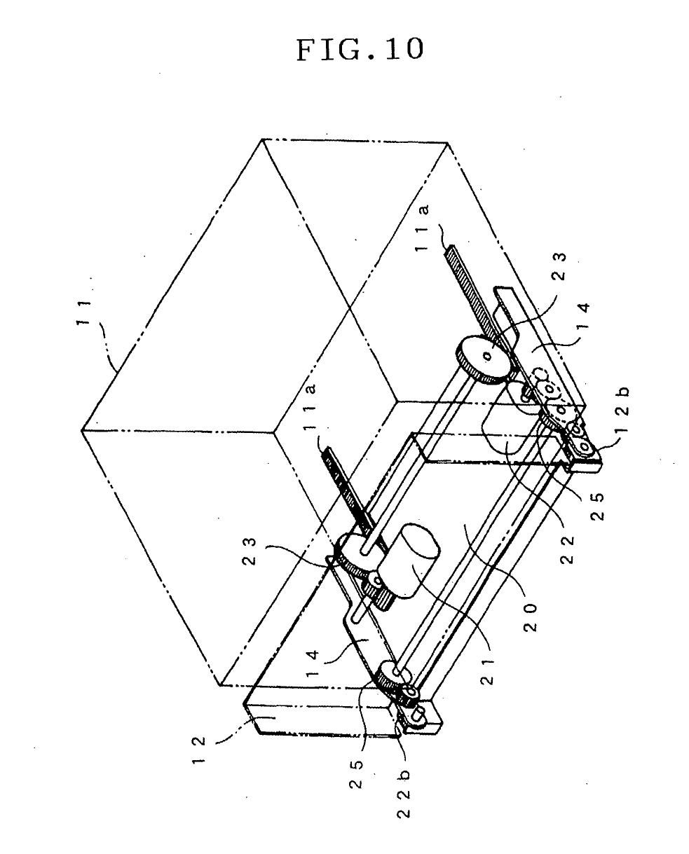

Thereafter, the frame-like cluster panel 31 is fixed to the vehicle, surrounding the periphery of the electronic device housing recess 30. A panel holder 12 shown in FIG. 5 is rotatively held by panel support arms 14 as shown in FIGS. 6 to 11. As shown in FIG. 10, the panel support arms 14 are integrally formed on the right and left sides of a panel support chassis 20. The panel support chassis 20 is supported by the vehicle-mounted electronic musical instrument chassis 11.

As detailed in FIG. 10, a motor 21 fixed to the panel support chassis 20 rotates pinions 23 via a gear train. The pinions 23 mesh with racks 11a fixed to the vehicle-mounted electronic musical instrument chassis 11. The panel support chassis 20 and panel support arms 14 integrally formed with the chassis 20, and move back and forth relative to the vehicle-mounted electronic musical instrument chassis 11 as the motor 21 rotates.

A motor 22 fixed to the panel support chassis 20 rotates pinions 25 via a gear train. The pinions 25 mesh with segment gears 12b fixed to the panel holder 12 so that the panel holder 12 rotates as the motor rotates 22.

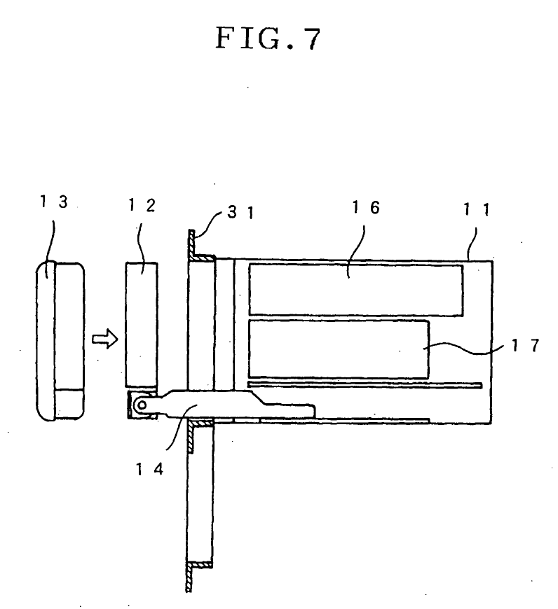

FIG. 6 shows the state that the vehicle-mounted electronic musical instrument chassis 21 is housed in the electronic device housing recess 30 and that the frame-like cluster panel 31 is fixed to the opening peripheral of the electronic device housing recess 30. Housed in the vehicle-mounted electronic musical instrument chassis 11 are a CD player mechanism 16, a cassette tape mechanism 17 and a printed circuit board 26. Although the panel holder 12 is located at a retracted position, as the power turns on when the panel holder 12 is connected to an unrepresented power supply cord, the motor 21 shown in FIG. 10 rotates so that the panel holder 12 moves forward to the position shown in FIG. 7.

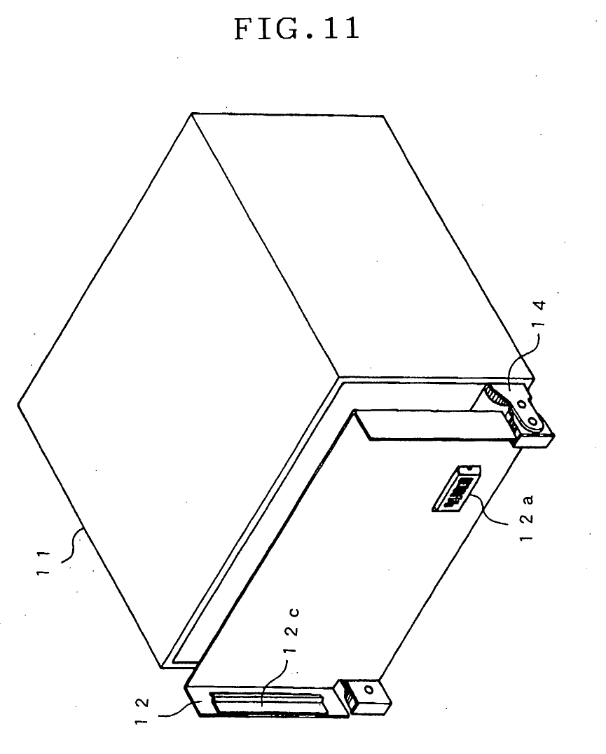

As shown in FIG. 11, the panel holder 12 is provided with a connector 12a and plate springs 12c. The operation panel 13 shown in FIGS. 5 and 7 is pushed toward the panel holder 12 as indicated by an arrow in FIG. 7 while the operation panel 13 is engaged with and held by the plate springs 12c. At this time, the operation panel 13 is held by the panel holder 12 and connected to the connector 12a so that the operation panel 13 is connected to the electronic musical instrument main body.

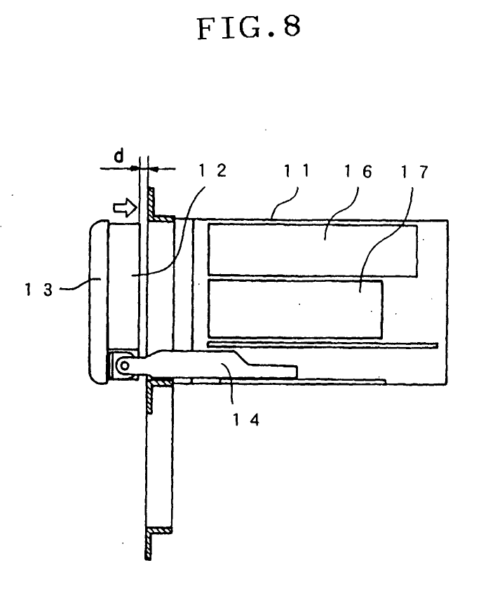

The vertical and horizontal sizes a1 and b1 of the operation panel 13 shown in FIG. 5 are greater than the vertical and horizontal sizes A and B of the inner periphery of the frame-like cluster panel 31. Therefore, as the operation panel 13 is retracted as indicated by an arrow in FIG. 8 by depressing a predetermined key of the operation panel 13, the operation panel 13 abuts on the frame-like cluster panel 31 and current flowing through the motor 21 increases.

The motor 21 is therefore stopped and thereafter, it is rotated in a reverse direction by a predetermined amount. The operation panel 13 moves forward departing from the frame-like cluster panel 31 by a distance d shown in FIG. 8. Since the operation panel 13 is moved departing from the frame-like cluster panel 31, it is possible to prevent the operation panel 13 from rubbing the frame-like cluster panel 31 to be otherwise caused by vibrations. By forcibly pulling the operation panel 13, the plate springs 12a are deflected so that the operation panel 13 can be dismounted from the panel holder 12.

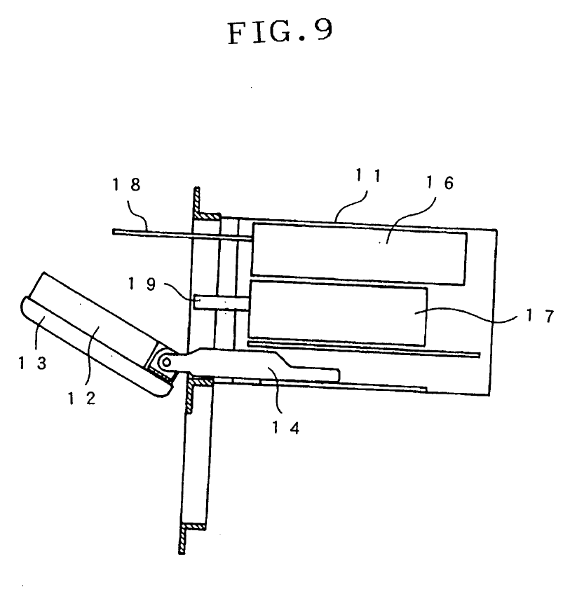

When a predetermined key of the operation panel 13 is depressed, the motor 22 starts rotating so that the operation panel 13 is swayed to the position shown in FIG. 9. In this state, a CD 18 or a cassette 19 can be inserted or pulled out. Upon operation of a key thereafter, the operation panel 13 resumes the original upright state. Since the operation panel 13 of this embodiment is greater than the inner periphery sizes of the frame-like cluster panel 31, the area to be occupied by the display panel and operation keys can be broadened.

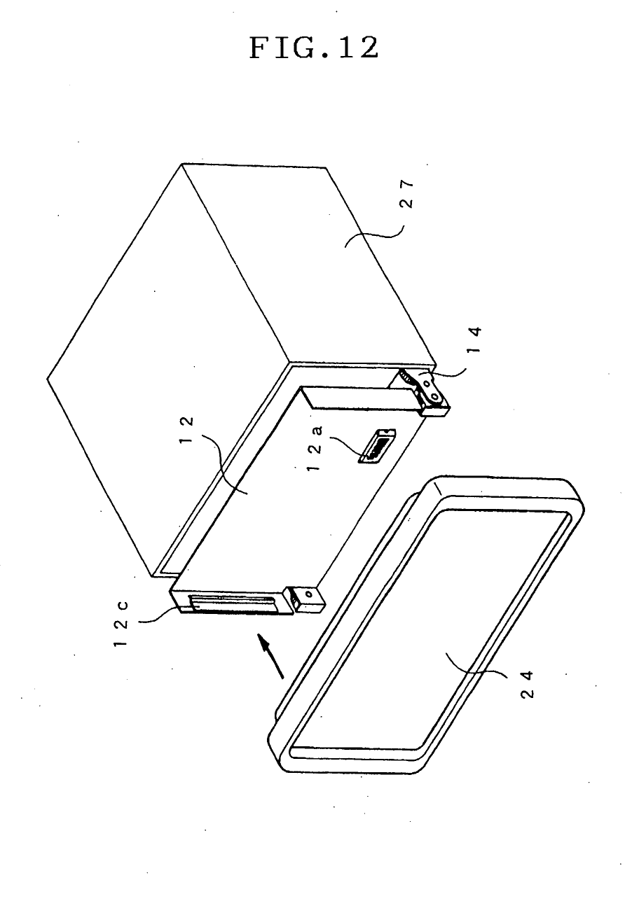

FIG. 12 is a broken perspective view partially showing a vehicle-mounted electronic device according to the second embodiment of the second invention. In this embodiment, the vehicle-mounted electronic device will be described by taking as an example a wide display panel used by a navigation apparatus or the like.

Similar to the first embodiment, a vehicle-mounted electronic device 27 is housed in a vehicle housing recess. As the operation panel support arms 14 move, the panel holder 12 projects out of the frame-like cluster panel.

An LCD monitor panel 24 is fixed to the panel holder 12 via plate springs 12c and connected to the vehicle-mounted electronic device main body via a connector 12a. The LCD monitor panel 24 is equipped with a touch panel so that the operation of the vehicle-mounted electronic device can also be controlled.

A map screen or the like may also be displayed. Similar to the first embodiment of the second invention, mounting and pulling out a recording medium can be made easy by swaying the LCD monitor panel 24. The sizes of the LCD monitor panel 24 can be set greater than the inner periphery sizes of the frame-like cluster panel.

Although the embodiments of the second invention are structured as described above, the invention is not limited only to these embodiments. For example, the operation panel and the like may be made slightly smaller then the inner periphery size of the frame-like cluster panel and made to be able to sway. Also in this case, the size of the operation panel can be made larger than the conventional operation panel which is used by sliding it, and the advantageous effects of the second invention can be obtained.

The method of driving the operation panel is not limited only to that described above, but other driving methods may also be adopted.

### INDUSTRIAL APPLICATION FIELDS

According to the mount structure for mounting a vehicle-mounted electronic device of the first invention, the front and rear position of the vehicle-mounted electronic device can be adjusted so as to match the thickness of the cluster panel without using a complicated mechanism, and in addition a large panel can be used. It is possible to prevent screws used for mounting a mounting bracket from entering the inside of the vehicle-mounted electronic device main body and destructing the inner mechanism.

According to a vehicle-mounted electronic device of the second invention, the operation panel and monitor of the vehicle-mounted electronic device can be made large irrespective of the sizes of the opening of a frame-like cluster panel so that the degree of design freedom can be improved. Since the display panel and operation keys can be made large, the device manipulation can be improved and the safety of vehicle running can be ensured.

1. A mount structure for mounting a vehicle-mounted electronic device by fixing said vehicle-mounted electronic device to a vehicle, fixing a cluster panel to the vehicle by inserting said vehicle-mounted electronic device therethrough, and fixing a panel broader than an opening of said cluster panel to said vehicle-mounted electronic device by covering said cluster panel with said panel,
wherein a subsidiary bracket is mounted on a side wall of main body of said vehicle-mounted electronic device in such a manner that a position of said subsidiary bracket can be adjusted, a mounting bracket is mounted with screws on said subsidiary bracket, and said mounting bracket is mounted with screws on the vehicle.

2. The mount structure for mounting the vehicle-mounted electronic device according to claim 1,
wherein said subsidiary bracket is mounted with screws on bosses formed on the side wall of the main body of said vehicle-mounted electronic device in such a manner that said screws used for mounting said mounting bracket on said subsidiary bracket are not abutted on the side wall of the main body of said vehicle-mounted electronic device.

3. A mount structure for mounting a vehicle-mounted electronic device by fixing said vehicle-mounted electronic device to a vehicle, fixing a cluster panel to the vehicle by inserting said vehicle-mounted electronic device therethrough, and fixing a panel broader than an opening of said cluster panel to said vehicle-mounted electronic device by covering said cluster panel with said panel,
wherein a plurality set of tapping holes are provided for mounting with screws a mounting bracket on a side wall of a main body of said vehicle-mounted electronic device, and said mounting bracket is mounted with screws on the side wall of by using a desired set of tapping holes in such a manner that a position of the main body of said vehicle-mounted electronic device can be adjusted when said mounting bracket is mounted with screws on the vehicle.

4. A vehicle-mounted electronic device, comprising:
a frame-like cluster panel mounted on an opening periphery of a housing recess of a vehicle, said housing recess accommodating a main body of said vehicle-mounted electronic device;
panel support arms inserted into said frame-like cluster panel, said panel support arms being movably mounted on the main body of said vehicle-mounted electronic device;
a panel holder mounted on top ends of said support arms; and
an operation panel or a monitor mounted on said panel holder, the outer vertical and horizontal sizes of said operation panel or said monitor being greater than an inner periphery area of said frame-like cluster panel, wherein said operation panel or said monitor is disposed forward relative to said frame-like cluster panel.

5. The vehicle-mounted electronic device according to claim 4,
wherein said panel support arms are made freely movable in and out of said frame-like cluster panel, and said operation panel or said monitor is held at a position remote from said frame-like cluster panel by a predetermined distance.

6. The vehicle-mounted electronic device according to claim 4 or 5,
wherein said operation panel or said monitor is rotatable so that a recording medium inlet of said vehicle-mounted electronic device can be opened and closed.
